(19) United States
(12) Patent Application Publication
(10) Pub. No.: US 2025/0176016 A1
(43) Pub. Date: May 29, 2025

(54) METHOD, DEVICE AND COMPUTER READABLE MEDIUM FOR COMMUNICATIONS

(71) Applicant: NEC CORPORATION, Tokyo (JP)

(72) Inventors: Zhaobang MIAO, Beijing (CN); Gang WANG, Beijing (CN)

(73) Assignee: NEC CORPORATION, Tokyo (JP)

(21) Appl. No.: 18/725,454

(22) PCT Filed: Dec. 30, 2021
(86) PCT No.: PCT/CN2021/143366

§ 371 Date: Jun. 28, 2024

(51) Int. Cl. H04W 74/0808; H04W 72/0453; H04W 72/25; H04W 72/56

(52) U.S. Cl. CPC H04W 74/0808; H04W 72/0453; H04W 72/25; H04W 72/56

(57) ABSTRACT

Embodiments of the present disclosure relate to methods, devices and computer readable media for communications. A method comprises determining, at a first terminal device, first sharing Channel Occupancy (CO) duration based on at least one of the following: remaining COT, a first priority value for a subsequent sidelink transmission of the first terminal device, or a first resource for the subsequent sidelink transmission. The method also comprises transmitting information about the first sharing CO duration.

### TECHNICAL FIELD

Embodiments of the present disclosure generally relate to the field of telecommunication, and in particular, to methods, devices and computer readable media for sidelink communication.

### BACKGROUND

Sidelink in unlicensed spectrum or band (SL-U) is a key topic in Release 18 of the 3rd Generation Partnership Project (3GPP). SL-U should base on New Radio (NR) sidelink and NR-U.

For communication in unlicensed band between a network device and terminal devices, resources within a Channel Occupancy (CO) may be shared in a Time Division Multiplex (TDM) mode according to the scheduling of the network device. For direct communication in unlicensed band between a terminal device and a further terminal device, a CO initiated or inherited by the terminal device may be shared with the further terminal device for the direct communication. If a duration of a sharing Channel Occupancy Time (COT) is improper, a higher priority traffic of the terminal device may not be ensured.

### SUMMARY

In general, example embodiments of the present disclosure provide methods, devices and computer readable media for communications.

In a first aspect, there is provided a method for communications. The method comprises determining, at a first terminal device, first sharing CO duration based on at least one of the following: remaining COT, a first priority value for a subsequent sidelink transmission of the first terminal device, or a first resource for the subsequent sidelink transmission. The method also comprises transmitting information about the first sharing CO duration.

In a second aspect, there is provided a method for communications. The method comprises receiving, at a second terminal device from a first terminal device, information about sharing CO; and determining COT for a second sidelink transmission of the second terminal device based on at least one of the following: the sharing CO, a first priority value for a subsequent sidelink transmission of the first terminal device, a second priority value for the second sidelink transmission, or a potential resource for the subsequent sidelink transmission.

In a third aspect, there is provided a terminal device. The terminal device comprises a processor and a memory storing instructions. The memory and the instructions are configured, with the processor, to cause the terminal device to perform the method according to the first aspect.

In a fourth aspect, there is provided a terminal device. The terminal device comprises a processor and a memory storing instructions. The memory and the instructions are configured, with the processor, to cause the terminal device to perform the method according to the second aspect.

In a fifth aspect, there is provided a computer readable medium having instructions stored thereon. The instructions, when executed on at least one processor of a device, cause the device to perform the method according to the first aspect.

In a sixth aspect, there is provided a computer readable medium having instructions stored thereon. The instructions, when executed on at least one processor of a device, cause the device to perform the method according to the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which implementations of the present disclosure can be implemented;

FIG. 2 illustrates an example of automatic gain control (AGC) symbol and guard period (GP) symbol in accordance with some embodiments of the present disclosure;

FIG. 3 illustrates an example of COT in accordance with some embodiments of the present disclosure;

FIG. 4 illustrates an example signaling chart showing an example process for CO sharing in accordance with some embodiments of the present disclosure;

FIGS. 5A to 5H illustrate an example of sharing CO duration in accordance with some embodiments of the present disclosure, respectively;

FIG. 6 illustrates a flowchart of an example method in accordance with some embodiments of the present disclosure;

FIG. 7 illustrates a flowchart of an example method in accordance with some other embodiments of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information. The terminal or the network device may work on several frequency ranges, e.g. FR1 (410 MHZ-7125 MHZ), FR2 (24.25 GHz to 71 GHZ), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

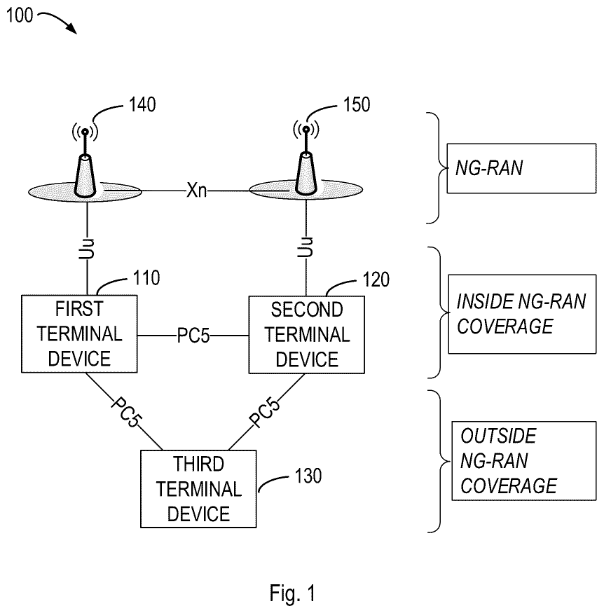

FIG. 1 illustrates a schematic diagram of an example communication network 100 in which embodiments of the present disclosure can be implemented. As shown in FIG. 1, the communication network 100 may include a terminal device 110, a terminal device 120, a terminal device 130, network devices 140 and 150. The network devices 140 and 150 may communicate with the terminal device 110, the terminal device 120 and the terminal device 130 via respective wireless communication channels.

In some embodiments, the network device 140 may be a gNB in NR, and the network device 150 may be an eNB in Long Term Evolution (LTE) system.

It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the communications in the communication network 100 may comprise sidelink communication. Sidelink communication is a wireless radio communication directly between two or more terminal devices, such as two or more terminal devices among the terminal device 110, the terminal device 120 and the terminal device 130. In this type of communication, the two or more terminal devices that are geographically proximate to each other can directly communicate without going through the network device 140 or 150 or through a core network. Data transmission in sidelink communication is thus different from typical cellular network communications, in which a terminal device transmits data to the network device 140 or 150 (i.e., uplink transmissions) or receives data from the network device 140 or 150 (i.e., downlink transmissions). In sidelink communication, data is transmitted directly from a source terminal device (such as the terminal device 110) to a target terminal device (such as the terminal device 120) through the Unified Air Interface, e.g., PC5 interface, (i.e., sidelink transmissions), as shown in FIG. 1.

Sidelink communication can provide several advantages, including reducing data transmission load on a core network, system resource consumption, transmission power consumption, and network operation costs, saving wireless spectrum resources, and increasing spectrum efficiency of a cellular wireless communication system.

In a sidelink communication system, the sidelink resource is used to transmit information between terminal devices. According to application scenarios, service types, etc., a sidelink communication manner includes but is not limited to device to device (D2D) communication, Vehicle-to-Everything (V2X) communication, etc.

V2X communication enables vehicles to communicate with other vehicles (i.e. Vehicle-to-Vehicle (V2V) communication), with infrastructure (i.e. Vehicle-to-Infrastructure (V2I), with wireless networks (i.e. Vehicle-to-Network (V2N) communication), with pedestrians (i.e. Vehicle-to-Pedestrian (V2P) communication), and even with the owner's home (i.e. Vehicle-to-Home (V2H)). Examples of infrastructure include roadside units such as traffic lights, toll gates and the like. V2X communication can be used in a wide range of scenarios, including in accident prevention and safety, convenience, traffic efficiency and clean driving, and ultimately in relation to autonomous or self-driving vehicles.

For sidelink communications, a terminal device uses resources in sidelink resource pools to transmit or receive signals. The sidelink resource pools include resources in time domain and frequency domain, which are dedicated resources of the sidelink communication, or shared by the sidelink communication and a cellular link.

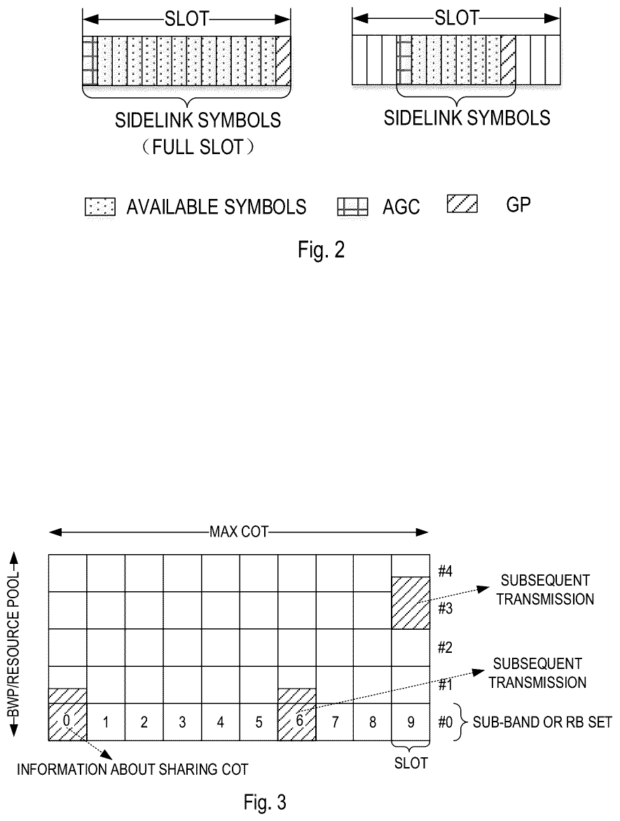

In a sidelink resource pool which may contain multiple slots and resource blocks (RBs), and all or part of the symbols in a slot can be used for sidelink transmission. Within a resource pool, among all the symbols configured for sidelink in each slot, the first symbol (i.e., the start symbol) is used as the automatic gain control (AGC) symbol, and the last symbol used as a guard period (GP) symbol. AGC symbols and GP symbols can be considered as fixed overheads in sidelink resource. In the description of the following embodiments, AGC symbols and GP symbols are included in the sidelink symbols which are indicated by the sidelink channel resource configuration, and AGC symbols carry redundancy sidelink information while GP symbols are not used for carrying sidelink information, as shown in FIG. 2.

The terminal device 110, the terminal device 120 and the terminal device 130 may use sidelink channels to transmit sidelink signaling or information. The sidelink channels include at least one of the following: a Physical Sidelink Control Channel (PSCCH) resource which is used for carrying sidelink control information (SCI), a Physical Sidelink Shared Channel (PSSCH) resource which is used for carrying sidelink data service information, a physical sidelink feedback channel (PSFCH) resource which is used for carrying sidelink ACK/NACK feedback information, a physical sidelink broadcast channel (PSBCH) resource which is used for carrying sidelink broadcast information, and a physical sidelink discovery channel (PSDCH) resource which is used for carrying a sidelink discovery signal.

FIG. 3 illustrates an example 300 of COT in accordance with some embodiments of the present disclosure. As shown in FIG. 3, in order to transmit PSCCH or PSSCH in slot 0, the first terminal device 110 may perform a Listen Before Talk (LBT) procedure of type 1 in sub-band #0 and #1 before slot 0. In other words, the first terminal device 110 may use a sub-band as a LBT unit in frequency domain. Alternatively, frequency region #0 and #1 may be referred as RB set #0 and #1, i.e., the first terminal device 110 may use a resource block (RB) set as a LBT unit in frequency domain. In response to a success of the LBT procedure before slot 0, the first terminal device 110 access to the channel and transmits PSCCH or PSSCH in slot 0. The first terminal device 110 may indicate, in sidelink control information (SCI) on PSCCH in slot 0, the resource in slot 0 for current transmission and resources in slots 6 and 9 reserved for subsequent transmissions. For example, each of the subsequent transmissions may comprise retransmission or PSFCH transmission.

Because the first terminal device 110 does not have any transmission in slots 1 to 5 and 7 to 9 in sub-band #0 and #1, the first terminal device 110 may share part or all of the remaining COT with at least one of the second terminal device 120 and the third terminal device 130. In this regard, the first terminal device 110 may transmit information about sharing CO duration in slot 0. For example, the first terminal device 110 may transmit the information about the sharing CO duration in SCI on PSCCH in slot 0. Hereinafter, a terminal device transmitting information about sharing CO duration is also referred to as a sharing terminal device, and a terminal device receiving the information about sharing CO duration is also referred to as an inheritor terminal device.

If the sharing CO duration comprises slots 0 to 9, the first terminal device 110 needs to contend sub-bands #0 and #1 with the second terminal device 120 and/or the terminal device 130 in slot 6 if the subsequent transmission occurred in slot 6. In this case, if the first terminal device 110 fails to access channel in slot 6, the first terminal device 110 will not perform the subsequent transmission in slot 6. This will adversely affect the subsequent transmission of the first terminal device 110 especially if the subsequent transmission of the first terminal device 110 has a higher priority. On the other hand, in order to ensure the subsequent transmission in slot 6 with the higher priority, the first terminal device 110 may share COT in slots 0 to 5 with the second terminal device 120 and/or the third terminal device 130. If the second terminal device 120 and the third terminal device 130 are not allowed to share COT in slots 6 to 9, resources in slots 6 to 9 may be wasted or occupied by other communication system.

It will be understood that whether the sharing CO duration comprises the slot 9 or not has no effect on first terminal device 110 because the subsequent transmission in slot 9 will be performed in sub-bands #3 and #4 instead of sub-bands #0 and #1.

Embodiments of the present disclosure provide a solution for sidelink transmission so as to solve the above problem and one or more of other potential problems. According to the solution, a first terminal device determines sharing CO duration based on at least one of the following: remaining COT, a priority value for a subsequent sidelink transmission of the first terminal device, or a resource for the subsequent sidelink transmission. In turn, the first terminal device transmits information about the first sharing CO duration. The solution provides a balanced way for higher priority transmission of both sharing terminal device and inheritor terminal device.

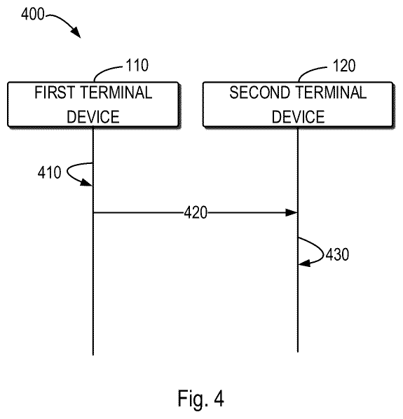

FIG. 4 illustrates an example signaling chart showing an example process 400 for CO sharing in accordance with some embodiments of the present disclosure. As shown in FIG. 4, the process 400 may involve the first terminal device 110 and the second terminal device 120 as shown in FIG. 1. It is to be understood that the process 400 may include additional acts not shown and/or may omit some acts as shown, and the scope of the present disclosure is not limited in this regard. In addition, it will be appreciated that, although primarily presented herein as being performed serially, at least a portion of the acts of the process 400 may be performed contemporaneously or in a different order than that presented in FIG. 4.

At shown in FIG. 4, the first terminal device 110 determines (410) first sharing CO duration based on at least one of the following: remaining COT, a first priority value for a subsequent sidelink transmission of the first terminal device 110, or a first resource for the subsequent sidelink transmission.

In some embodiments, the subsequent sidelink transmission of the first terminal device 110 may comprise retransmission or PSFCH transmission.

In turn, the first terminal device 110 transmits (420) information about the first sharing CO duration. In some embodiments, the first terminal device 110 may transmit the information about the first sharing CO duration in a dedicated field of SCI. The SCI maybe a SCI with new format comparing with existing SCI formats. Correspondingly, the second terminal device 120 receives the information about the first sharing CO duration.

In a first embodiment, the first terminal device 110 may determine whether a priority threshold is configured or pre-configured. If the priority threshold is configured or pre-configured, the first terminal device 110 may compare the first priority value for the subsequent sidelink transmission of the first terminal device 110 with the priority threshold. If the first priority value is below the priority threshold, the first terminal device 110 may compare the remaining COT with a transmission offset. The transmission offset is a time offset between a second resource where the information about the first sharing CO duration is transmitted and the first resource for the subsequent sidelink transmission.

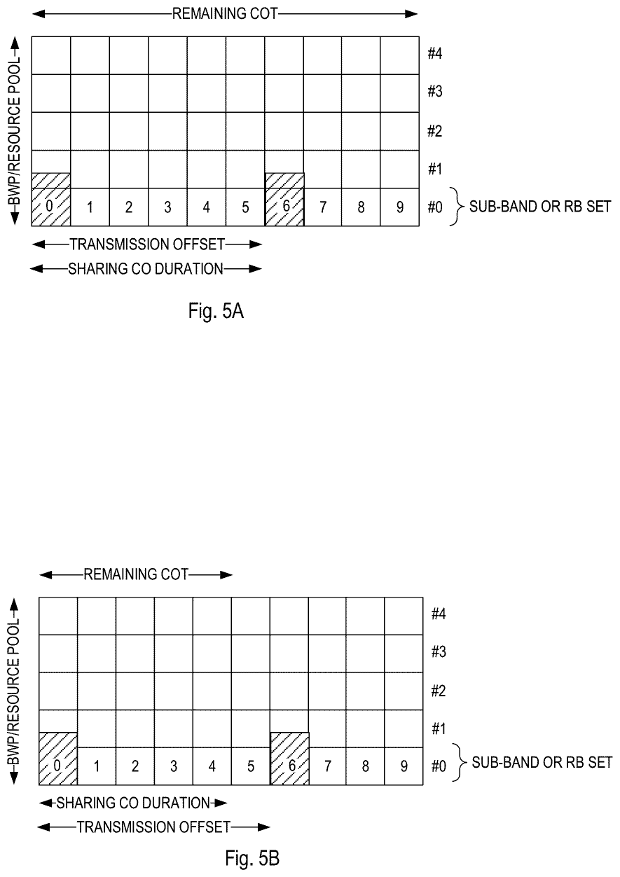

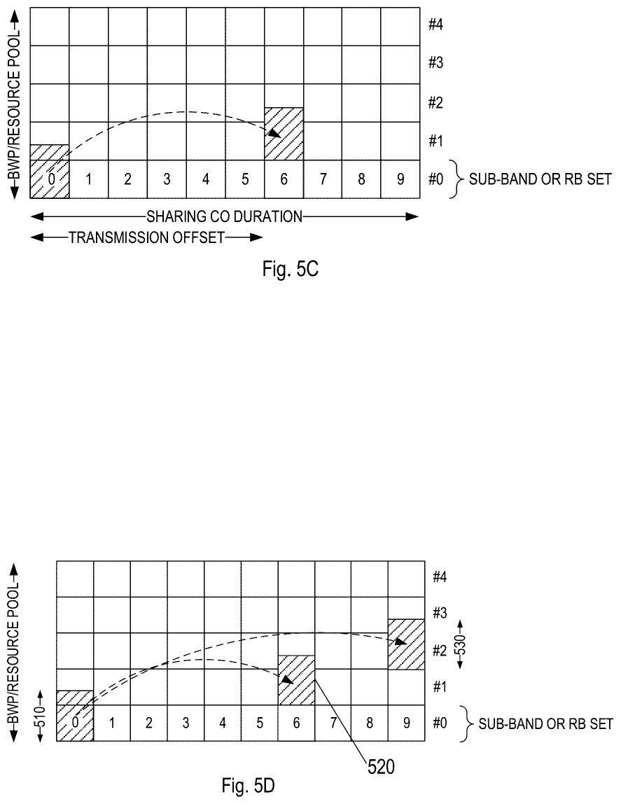

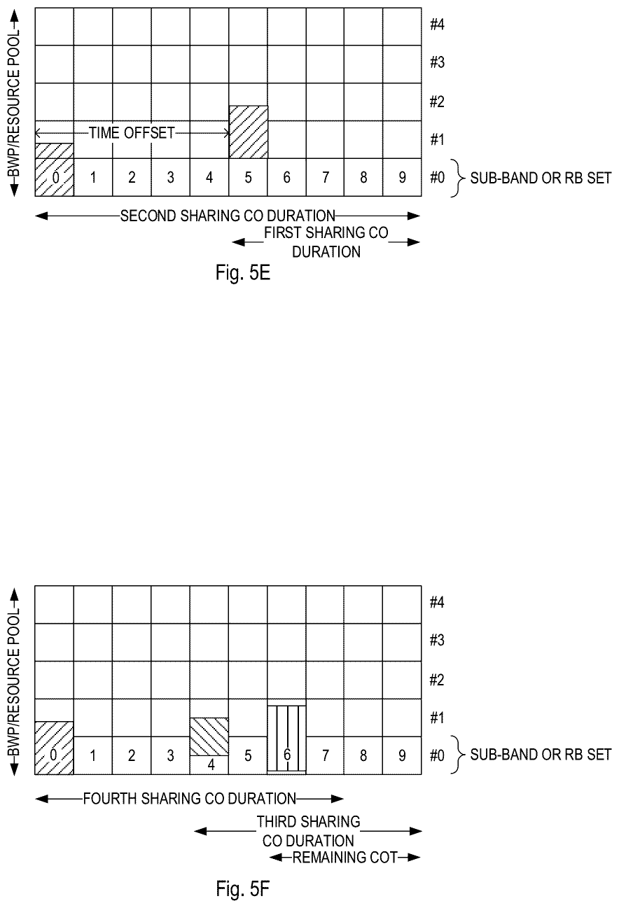

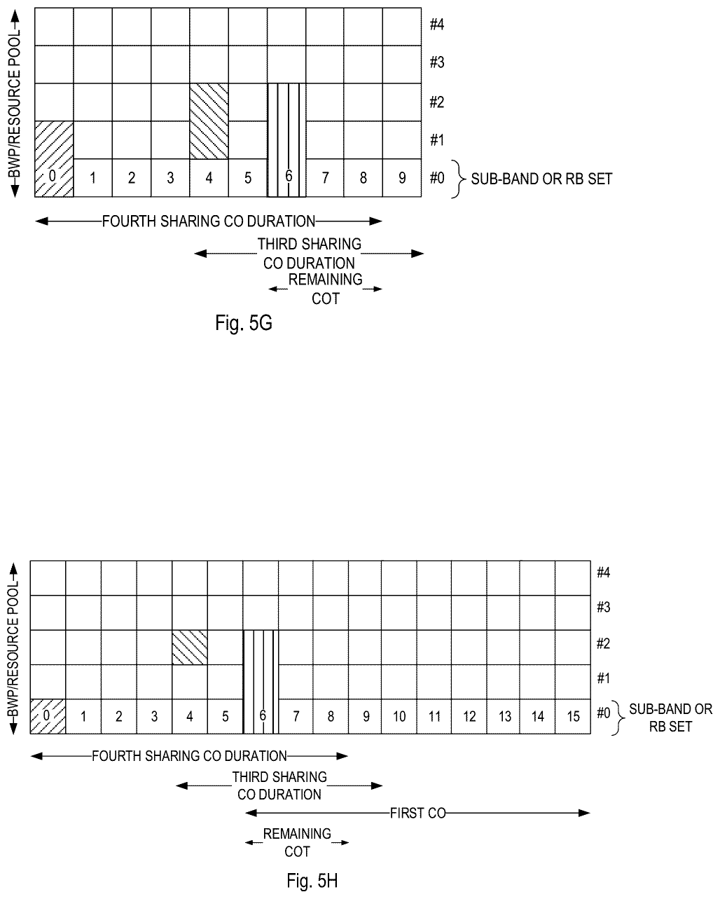

If the remaining COT is less than the transmission offset, the first terminal device 110 may determine the remaining COT as the first sharing CO duration. On the other hand, if the transmission offset is less than the remaining COT, the first terminal device 110 may determine the transmission offset as the first sharing CO duration. This will be described with reference to FIGS. 5A and 5B.

FIGS. 5A and 5B illustrate an example of sharing CO duration in accordance with some embodiments of the present disclosure, respectively. In the examples of FIGS. 5A and 5B, in response to a success of the LBT procedure before slot 0, the first terminal device 110 transmits PSCCH or PSSCH and the information about the first sharing CO duration in slot 0. The first terminal device 110 may also indicate, in SCI on PSCCH in slot 0, the resource in slot 0 for current transmission and a resource in slot 6 reserved for a subsequent sidelink transmission.

In addition, in the examples of FIGS. 5A and 5B, the priority threshold is configured or pre-configured and a priority value for the subsequent sidelink transmission in slot 6 is below the priority threshold.

In the example of FIG. 5A, the remaining COT comprises slots 0 to 9, and the transmission offset between a resource (slot 0) where the information about the first sharing CO duration is transmitted and a resource (slot 6) for the subsequent sidelink transmission comprises slots 0 to 5. In this case, the first terminal device 110 determines the transmission offset as the first sharing CO duration. That is, the first sharing CO duration comprises slots 0 to 5. It will be understood that although it is described that the first sharing CO duration comprises slots 0 to 5, the second terminal device 120 may only use slots 1 to 5 for its sidelink transmission because the first terminal device 110 has used slot 0 to transmit the information about the first sharing CO duration.

In the example of FIG. 5B, the remaining COT comprises slots 0 to 4, and the transmission offset between a resource (slot 0) where the information about the first sharing CO duration is transmitted and a resource (slot 6) for the subsequent sidelink transmission comprises slots 0 to 5. In this case, the first terminal device 110 determines the remaining COT as the first sharing CO duration. That is, the first sharing CO duration comprises slots 0 to 4.

In some embodiments, if the first priority value is equal to or greater than the priority threshold or if the priority threshold is not configured or pre-configured, the first terminal device 110 may determine the first sharing CO duration as the remaining COT.

In a second embodiment, the first terminal device 110 may determine the first sharing CO duration as the remaining COT without comparing the first priority value with the priority threshold.

In a third embodiment, the first terminal device 110 may determine the first sharing CO duration as the transmission offset without comparing the first priority value with the priority threshold.

In some embodiments, the first terminal device 110 may receive a radio resource control (RRC) configuration or an RRC pre-configuration. The RRC configuration or RRC pre-configuration may indicate which of the first, second and third embodiment is adopted by the first terminal device 110. The first terminal device 110 may determine the first sharing CO duration based on the RRC configuration or RRC pre-configuration.

In some embodiments, the first terminal device 110 may transmit the information about the first sharing CO duration with a first sidelink transmission in a third resource. The LBT units associated with the third resource overlap in frequency domain with the first resource for the subsequent sidelink transmission. For example, consider the examples of FIGS. 5A and 5B. The first terminal device 110 transmits the information about the first sharing CO duration in slot 0 with a first sidelink transmission in resource 0 which belongs to sub-bands #0 and #1. The first terminal device 110 transmits the subsequent sidelink transmission in resource 6 which also belongs to sub-bands #0 and #1.

With continued reference to FIG. 4, upon receiving the information about the first sharing CO duration from the first terminal device 110, the second terminal device 120 determines (430) COT for a second sidelink transmission of the second terminal device 120 based on at least one of the following: the first sharing CO duration, the first priority value for the subsequent sidelink transmission of the first terminal device 110, a second priority value for the second sidelink transmission, or a potential resource for the subsequent sidelink transmission.

In embodiments where the subsequent sidelink transmission of the first terminal device 110 is PSSCH retransmission, the second terminal device 120 may determine the potential resource for the subsequent sidelink transmission from Time resource assignment field in SCI transmitted by the first terminal device 110.

In embodiments where the subsequent sidelink transmission of the first terminal device 110 is PSFCH transmission, the second terminal device 120 may determine the potential resource for the subsequent sidelink transmission from possible PSFCH occasions predefined for the sidelink resource pool, for example based on the PSFCH resource configuration in the resource pool.

In some embodiments, the second terminal device 120 may compare the second priority value for the second sidelink transmission with the first priority value for the subsequent sidelink transmission. If the second priority value is less than the first priority value, the second terminal device 120 may determine the COT for the second sidelink transmission of the second terminal device 120 as the first sharing CO duration. For example, the first priority value for the subsequent sidelink transmission may be equal to a value in a priority field in the SCI transmitted by the first terminal device 110.

On the other hand, if the second priority value is equal to or greater than the first priority value, the second terminal device 120 may determine a transmission offset between a resource where the information about the first sharing CO duration is received and the potential resource for the subsequent sidelink transmission.

If the first sharing CO duration is less than the transmission offset, the second terminal device 120 may determine the COT as the first sharing CO duration. On the other hand, if the transmission offset is less than the first sharing CO duration, the second terminal device 120 may determine the COT as the transmission offset. This will be described with reference to FIG. 5C.

FIG. 5C illustrates an example of sharing CO duration in accordance with some embodiments of the present disclosure. In the example of FIG. 5C, in response to a success of the LBT procedure before slot 0, the first terminal device 110 transmits PSCCH or PSSCH and the information about the first sharing CO duration in slot 0. The first terminal device 110 may also indicate, in SCI on PSCCH in slot 0, the resource in slot 0 for current transmission and a resource in slot 6 reserved for a subsequent sidelink transmission.

In addition, in the example of FIG. 5C, the information about the first sharing CO duration in slot 0 indicates that the first sharing CO duration comprises slots 0 to 9. The transmission offset between the resource where the information about the first sharing CO duration is received and the potential resource for the subsequent sidelink transmission comprises slots 0 to 5.

If the second priority value is less than the first priority value, the second terminal device 120 may determine a duration of the CO for the second sidelink transmission of the second terminal device 120 as the first sharing CO duration. On the other hand, if the second priority value is equal to or greater than the first priority value, the second terminal device 120 may determine the transmission offset and compare the sharing CO duration with the transmission offset. In the example of FIG. 5C, because the transmission offset is less than the first sharing CO duration, the second terminal device 120 may determine a duration of the CO as the transmission offset.

In some embodiments, the second terminal device 120 may receive, from the first terminal device 110, resource assignment information for the first terminal device 110. In turn, the second terminal device 120 may determine, based on the resource assignment information, a shared sub-band or RB set associated with the first sharing CO duration.

In some embodiments, the second terminal device 120 may determine, based on the resource assignment information, a plurality of time and frequency resources for the first terminal device 110. In turn, the second terminal device 120 may determine at least one sub-band or RB set where the first time and frequency resource among the plurality of time and frequency resources is located in the shared sub-band or RB set. This will be described with reference to FIG. 5D.

FIG. 5D illustrates an example of sharing CO duration in accordance with some embodiments of the present disclosure. In the example of FIG. 5D, in response to a success of the LBT procedure before slot 0, the first terminal device 110 transmits PSCCH or PSSCH and the information about the first sharing CO duration in slot 0. The first terminal device 110 may also indicate, in SCI on PSCCH in slot 0, the resource in slot 0 for current transmission and a resource in slots 6 and 9 reserved for subsequent sidelink transmissions.

Upon receiving the SCI from the first terminal device 110, the second terminal device 120 may determine three time-frequency resources from fields “Frequency resource assignment” and “time resource assignment” of the SCI. The three time-frequency resources comprises a resource (the earliest or starting resource) 510 located in sub-bands #0 and #1 in slot 0, a resource 520 located in sub-bands #1 and #2 in slot 6, and a resource 530 located in sub-bands #2 and #3 in slot 9. The second terminal device 120 may determine sub-bands #0 and #1 where the resource 510 is located as the shared sub-bands or RB set.

In some embodiments, the first terminal device 110 may determine remaining time of a CO initiated by the first terminal device 110 as the remaining COT.

In some embodiments, the first terminal device 110 may receive information about second sharing CO duration from the third terminal device 130. In turn, the first terminal device 110 may determine an end of the second sharing CO duration as an end of the remaining COT.

In some embodiments, the first terminal device 110 may receive the information about the second sharing CO duration in a fourth resource. In such some embodiments, the first terminal device 110 may transmit the information about the first sharing CO duration in a fifth resource. In order to ensure the first terminal device 110 has time to process the information about the second sharing CO duration and prepare the information about the first sharing CO duration, a time offset between the fourth resource and the fifth resource may be greater than an offset threshold. For example, consider an example as shown in FIG. 5E. The first terminal device 110 receives the information about the second sharing CO duration from the third terminal device 130 in slot 0. The first terminal device 110 transmits the information about the first sharing CO duration in slot 5. There are five slots between the slot 0 and slot 5. In this example, the offset threshold may be one slot or a few microseconds

In some embodiments, the first terminal device 110 may receive information about third sharing CO duration from a fourth terminal device (not shown) and information about fourth sharing CO duration from a fifth terminal device (not shown). The first terminal device 110 may compare an end of the third sharing CO duration with an end of the fourth sharing CO duration. In turn, the first terminal device 110 may determine, based on the comparison, an end of one of the third sharing CO duration and the fourth sharing CO duration as an end of the remaining COT.

In some embodiments, if an end of the third sharing CO duration is later than an end of the fourth sharing CO duration, the first terminal device 110 may determine the end of the third sharing CO duration as an end of the remaining COT. This will be described with reference to FIG. 5F.

FIG. 5F illustrates an example of sharing CO duration in accordance with some embodiments of the present disclosure. In the example of FIG. 5F, the fifth terminal device transmits the information about fourth sharing CO duration in slot 0, and the fourth terminal device transmits the information about third sharing CO duration in slot 4. The fourth sharing CO duration comprises slots 0 to 7, and the third sharing CO duration comprises slots 4 to 9. Upon receiving the information about third sharing CO duration and the information about fourth sharing CO duration, the first terminal device 110 may compare the end of the third sharing CO duration with the end of the fourth sharing CO duration. Because the end of the third sharing CO duration is later than the end of the fourth sharing CO duration, the first terminal device 110 determines the end of the third sharing CO duration as an end of the remaining COT.

In such embodiments, a shared sub-band or RB set associated with the third sharing CO duration may totally overlap with a shared sub-band or RB set associated with the fourth sharing CO duration. For example, consider the example as shown in FIG. 5F. Shared sub-bands associated with the third sharing CO duration comprise sub-bands #0 and #1. Shared sub-bands associated with the fourth sharing CO duration also comprise sub-bands #0 and #1. Thus, the shared sub-bands associated with the third sharing CO duration totally overlap with the shared sub-bands associated with the fourth sharing CO duration.

In some embodiments, if an end of the third sharing CO duration is identical to an end of the fourth sharing CO duration, the first terminal device 110 may determine the end of the third sharing CO duration or the end of the fourth sharing CO duration as an end of the remaining COT.

In some embodiments, if the end of the third sharing CO duration is identical to the end of the fourth sharing CO duration, comparing a first Channel Access Priority Class (CAPC) associated with the third sharing CO duration with a second CAPC associated with the fourth sharing CO duration. If the first CAPC is higher than the second CAPC, the first terminal device 110 may determine the first CAPC as an associated CAPC of the remaining COT. If the second CAPC is higher than the first CAPC, the first terminal device 110 may determine the second CAPC as the associated CAPC of the remaining COT.

In some embodiments, a shared sub-band or RB set associated with the third sharing CO duration may not totally overlap with a shared sub-band or RB set associated with the fourth sharing CO duration. In such embodiments, if an end of the third sharing CO duration is earlier than an end of the fourth sharing CO duration, the first terminal device 110 may determine the end of the third sharing CO duration as an end of the remaining COT. This will be described with reference to FIGS. 5G and 5H.

FIGS. 5G and 5H illustrate an example of sharing CO duration in accordance with some embodiments of the present disclosure, respectively. In the example of FIG. 5G, the fifth terminal device transmits the information about fourth sharing CO duration in slot 0, and the fourth terminal device transmits the information about third sharing CO duration in slot 4. The fourth sharing CO duration comprises slots 0 to 8, and the third sharing CO duration comprises slots 4 to 9. Shared sub-bands associated with the fourth sharing CO duration also comprise sub-bands #0 and #1. Shared sub-bands associated with the third sharing CO duration comprise sub-bands #1 and #2. Thus, the shared sub-bands associated with the third sharing CO duration do not totally overlap with the shared sub-bands associated with the fourth sharing CO duration.

Upon receiving the information about third sharing CO duration and the information about fourth sharing CO duration, the first terminal device 110 may compare the end of the third sharing CO duration with the end of the fourth sharing CO duration. Because the end of the fourth sharing CO duration is earlier than the end of the third sharing CO duration, the first terminal device 110 determines the end of the fourth sharing CO duration as an end of the remaining COT.

In the example of FIG. 5H, the fifth terminal device transmits the information about fourth sharing CO duration in slot 0, and the fourth terminal device transmits the information about third sharing CO duration in slot 4. In addition, the first terminal device 110 obtains first CO in slot 6 by performing a LBT type 1 procedure. The fourth sharing CO duration comprises slots 0 to 8, the third sharing CO duration comprises slots 4 to 9, and a duration of the first CO comprises slots 6 to 15. A shared sub-band associated with the fourth sharing CO duration also comprises sub-band #0. A shared sub-band associated with the third sharing CO duration comprises sub-band #2. A shared sub-band associated with the first COT comprises sub-band #1. Thus, the shared sub-band associated with the third sharing CO duration does not totally overlap with the shared sub-band associated with the fourth sharing CO duration and the shared sub-band associated with the first COT.

Upon receiving the information about third sharing CO duration and the information about fourth sharing CO duration, the first terminal device 110 may compare the end of the third sharing CO duration with the end of the fourth sharing CO duration and the end of the first COT. Because the end of the fourth sharing CO duration is earlier than the ends of the third sharing CO duration and the first COT, the first terminal device 110 determines the end of the fourth sharing CO duration as an end of the remaining COT.

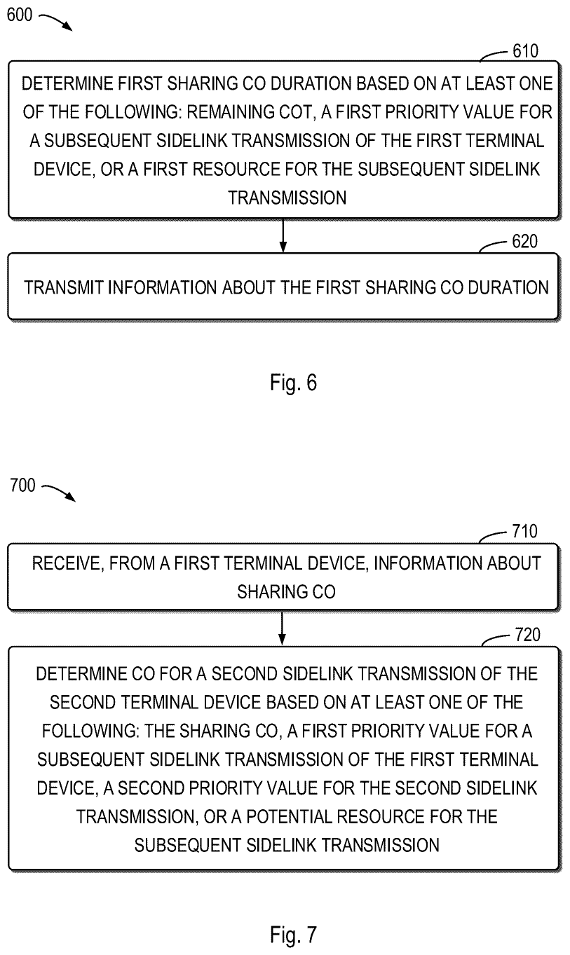

FIG. 6 illustrates a flowchart of an example method 600 in accordance with some embodiments of the present disclosure. In some embodiments, the method 600 can be implemented at a terminal device, such as one of the terminal devices 110, 120 and 130 as shown in FIG. 1. For the purpose of discussion, the method 600 will be described with reference to FIG. 1 as performed by the terminal device 110 without loss of generality.

At block 610, the first terminal device 110 determines first sharing CO duration based on at least one of the following: remaining COT, a first priority value for a subsequent sidelink transmission of the first terminal device, or a first resource for the subsequent sidelink transmission.

At block 620, the first terminal device 110 transmits information about the first sharing CO duration.

In some embodiments, determining the first sharing CO duration comprises: if the first priority value is below a priority threshold, comparing the remaining COT with a transmission offset, the transmission offset being time offset between a second resource where the information about the first sharing CO duration is transmitted and the first resource for the subsequent sidelink transmission; and if the remaining COT is less than the transmission offset, determining the remaining COT as the first sharing CO duration; and if the transmission offset is less than the remaining COT, determining the transmission offset as the first sharing CO duration.

In some embodiments, determining the first sharing CO duration comprises: if the first priority value is equal to or greater than a priority threshold or if the priority threshold is not configured, determining the remaining COT as the first sharing CO duration.

In some embodiments, transmitting the information about the first sharing CO duration comprises: transmitting the information with a first sidelink transmission in a third resource, the third resource overlapping in frequency domain with the first resource for the subsequent sidelink transmission.

In some embodiments, the method 600 further comprises: determining remaining time of a channel occupancy (CO) initiated by the first terminal device as the remaining COT.

In some embodiments, the method 600 further comprises: receiving information about second sharing CO duration from a third terminal device; and determining an end of the second sharing CO duration as an end of the remaining COT.

In some embodiments, receiving information about the second sharing CO duration comprises: receiving the information about the second sharing CO duration in a fourth resource; and transmitting the information about the first sharing CO duration comprises: transmitting the information about the first sharing CO duration in a fifth resource, an time offset between the fourth resource and the fifth resource being greater than an offset threshold.

In some embodiments, the method 600 further comprises: receiving information about third sharing CO duration from a fourth terminal device; receiving information about fourth sharing CO duration from a fifth terminal device; comparing an end of the third sharing CO duration with an end of the fourth sharing CO duration; and determining, based on the comparison, an end of one of the third sharing CO duration and the fourth sharing CO duration as an end of the remaining COT.

In some embodiments, a shared sub-band or resource block (RB) set associated with the third sharing CO duration totally overlaps with a shared sub-band or RB set associated with the fourth sharing CO duration.

In some embodiments, determining the remaining COT comprises: if an end of the third sharing CO duration is later than an end of the fourth sharing CO duration, determining the end of the third sharing CO duration as an end of the remaining COT.

In some embodiments, determining the remaining COT comprises: if an end of the third sharing CO duration is identical to an end of the fourth sharing CO duration, determining the end of the third sharing CO duration or the end of the fourth sharing CO duration as an end of the remaining COT.

In some embodiments, the method 600 further comprises: if the end of the third sharing CO duration is identical to the end of the fourth sharing CO duration, comparing a first Channel Access Priority Class (CAPC) associated with the third sharing CO duration with a second CAPC associated with the fourth sharing CO duration; if the first CAPC is higher than the second CAPC, determining the first CAPC as an associated CAPC of the remaining COT; and if the second CAPC is higher than the first CAPC, determining the second CAPC as the associated CAPC of the remaining COT.

In some embodiments, a shared sub-band or resource block (RB) set associated with the third sharing CO duration does not totally overlap with a shared sub-band or resource block (RB) set associated with the fourth sharing CO duration.

In some embodiments, determining the remaining COT comprises: if an end of the third sharing CO duration is earlier than an end of the fourth sharing CO duration, determining the end of the third sharing CO duration as an end of the remaining COT.

FIG. 7 illustrates a flowchart of an example method 700 in accordance with some embodiments of the present disclosure. In some embodiments, the method 700 can be implemented at a terminal device, such as one of the terminal devices 110, 120 and 130 as shown in FIG. 1. For the purpose of discussion, the method 700 will be described with reference to FIG. 1 as performed by the terminal device 120 without loss of generality.

At block 710, the second terminal device 120 receives information about sharing CO from a first terminal device.

At block 720, the second terminal device 120 determines CO for a second sidelink transmission of the second terminal device based on at least one of the following: the sharing CO, a first priority value for a subsequent sidelink transmission of the first terminal device, a second priority value for the second sidelink transmission, or a potential resource for the subsequent sidelink transmission.

In some embodiments, determining the CO comprises: if the second priority value is less than the first priority value, determining the CO as the sharing CO.

In some embodiments, determining the CO comprises: if the second priority value is equal to or greater than the first priority value, determining a transmission offset between a resource where the information about the sharing CO is received and the potential resource; if a duration of the sharing CO is less than the transmission offset, determining the CO as the sharing CO; and if the transmission offset is less than a duration of the sharing CO, determining a duration of the CO as the transmission offset.

In some embodiments, the method 700 further comprises: receiving, from the first terminal device, resource assignment information for the first terminal device; and determining, based on the resource assignment information, a shared sub-band or resource block (RB) set associated with the sharing CO.

In some embodiments, determining the shared sub-band or RB set comprises: determining, based on the resource assignment information, a plurality of frequency resources for the first terminal device; and determining at least one sub-band or RB set where a starting frequency resource among the plurality of frequency resources is located as the shared sub-band or RB set.

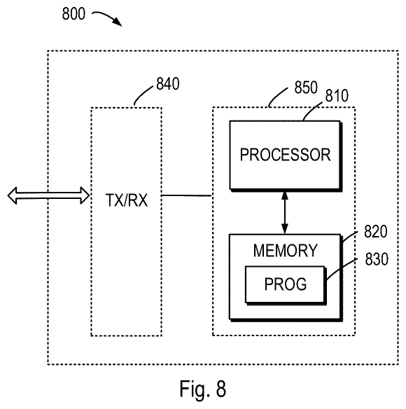

FIG. 8 is a simplified block diagram of a device 800 that is suitable for implementing some embodiments of the present disclosure. The device 800 can be considered as a further example embodiment of the terminal device 110 or 120 as shown in FIG. 1. Accordingly, the device 800 can be implemented at or as at least a part of the terminal device 110 or 120.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 820 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2 interface for bidirectional communications between gNBs or eNBs, SI interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 830 is assumed to include program instructions that, when executed by the associated processor 810, enable the device 800 to operate in accordance with the embodiments of the present disclosure, as discussed herein with reference to FIGS. 1 to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 1 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-23. (canceled)

24. A method performed by a first terminal device, comprising:
receiving sidelink control information (SCI) with physical sidelink control channel (PSCCH) or physical sidelink shared channel (PSSCH) transmission within a resource block (RB) set(s) in a first slot, the SCI comprising channel occupancy (CO) sharing information; and
transmitting a sidelink transmission within the RB set(s) based on the SCI.

25. The method of claim 24, wherein the SCI further comprises a frequency resource assignment field and a time resource assignment field associated with resource reservation, wherein the frequency resource assignment field indicates the RB set(s).

26. The method of claim 25, wherein the time resource assignment field indicates a second number of slots, and the RB set(s) is associated with the first slot of the second number of slots.

27. A method performed by a second terminal device, comprising:
transmitting sidelink control information (SCI) with physical sidelink control channel (PSCCH) or physical sidelink shared channel (PSSCH) transmission within a resource block (RB) set(s) in a first slot, the SCI comprising channel occupancy (CO) sharing information; and
receiving a sidelink transmission within the RB set(s) based on the SCI.

28. The method of claim 27, wherein the SCI further comprises a frequency resource assignment field and a time resource assignment field associated with resource reservation, wherein the frequency resource assignment field indicates the RB set(s).

29. The method of claim 28, wherein the time resource assignment field indicates a second number of slots, and the RB set(s) is associated with the first slot of the second number of slots.

30. A first terminal device, comprising a processor configured to:
receive sidelink control information (SCI) with physical sidelink control channel (PSCCH) or physical sidelink shared channel (PSSCH) transmission within a resource block (RB) set(s) in a first slot, the SCI comprising channel occupancy (CO) sharing information; and
transmit a sidelink transmission within the RB set(s) based on the SCI.

31. The first terminal device of claim 30, wherein the SCI further comprises a frequency resource assignment field and a time resource assignment field associated with resource reservation, wherein the frequency resource assignment field indicates the RB set(s).

32. The first terminal device of claim 31, wherein the time resource assignment field indicates a second number of slots, and the RB set(s) is associated with the first slot of the second number of slots.
